(19) United States
(12) Patent Application Publication
(10) Pub. No.: US 2024/0426870 A1
(43) Pub. Date: Dec. 26, 2024

(54) SCANNING PROBE MICROSCOPE

(71) Applicant: SHIMADZU CORPORATION, Kyoto-shi (JP)

(72) Inventor: Kenji YAMASAKI, Kyoto-shi (JP)

(21) Appl. No.: 18/686,280

(22) PCT Filed: Mar. 16, 2022
(86) PCT No.: PCT/JP2022/011934

§ 371 Date: Jul. 1, 2024

(30) Foreign Application Priority Data
Sep. 14, 2021 (JP) 2021-149504

(51) Int. Cl. G01Q 20/02; G01Q 70/08

(52) U.S. Cl. CPC G01Q 20/02; G01Q 70/08

(57) ABSTRACT

A control device is configured to perform control to move the optical microscope from an initial position to a position at which the optical microscope is focused on the observation target while confirming the focus, store information capable of identifying a relative position between the optical microscope and the observation target in a focused state (S3), move the optical microscope to the relative position based on the stored information and then move the optical microscope to a position at which the optical microscope is focused on the observation target while confirming the focus.

### TECHNICAL FIELD

The present invention relates to a scanning probe microscope.

### BACKGROUND ART

In a scanning probe microscope, a probe provided on the tip of a cantilever is positioned to face the sample. In a scanning probe microscope, the change in warping or vibration of a cantilever approached to a sample is detected by a photodetector by converting the change in the reflected light of laser irradiated on the back surface of the cantilever. The photodetector detects the change in the position, intensity, and phase, etc., of the reflected light. A scanning probe microscope measures various physical information on a sample by converting the information detected by a photodetector into various physical information.

In a scanning probe microscope, in order to observe the state of an observation target, such as a sample and a cantilever, an optical microscope is positioned at a location capable of acquiring an enlarged image of the observation target in the observation target region including the sample and the cantilever.

In a scanning probe microscope, the optical axis adjustment of the laser light is performed prior to the measurement of the sample to ensure that the laser light is correctly irradiated onto the back surface of the cantilever. In the case of performing the optical axis adjustment of the laser light, it is necessary to focus the optical microscope on the observation target, such as the back surface of the cantilever, in order to ensure that the laser light is correctly irradiated onto the back surface of the cantilever.

When focusing an optical microscope on an observation target, the operation of focusing the optical microscope on the observation target is carried out by moving the position of the optical microscope, for example, moving the optical microscope from the initial position, such as the position most distant from the observation target, toward the observation target to a position at which the optical microscope is focused on the observation target.

When carrying out the operation of focusing the optical microscope on the observation target, it is necessary to move the optical microscope over a relatively wide range while confirming whether the optical microscope is focused on the observation target by performing the image processing of the observation target in the observation target region based on the image obtained by the optical microscope.

As an example of the technology related to an optical axis adjustment of laser light, Patent Document 1 (Japanese Patent No. 6627953) discloses a scanning probe microscope equipped with an image processing unit that identifies the spot position of the laser light and the tip position of the cantilever based on an image. The scanning probe microscope disclosed in Patent Document 1 is further equipped with an optical axis adjustment unit for adjusting the position of the laser light source based on the identified spot position of the laser light and the identified tip position of the cantilever.

### PRIOR ART DOCUMENT

### Patent Document

Patent Document 1: Japanese Patent No. 6627953

### SUMMARY OF THE INVENTION

### Problems to be Solved by the Invention

However, in a conventional scanning probe microscope, in order to focusing the optical microscope on the observation target, the optical microscope is moved over a relatively wide range while confirming whether the optical microscope is focused on the observation target by performing image processing. This limits the speed at which the optical microscope is moved to focus the microscope on the observation target. The limited speed at which the optical microscope can be moved increases the time required to focus the optical microscope on the observation target.

The present invention has been made to solve such problems, and the purpose of the present invention is to shorten the time required for focusing an optical microscope on an observation target.

### Means for Solving the Problems

A scanning probe microscope according to one aspect of the present invention includes:
a cantilever equipped with a probe to be positioned to face a sample; and
an optical microscope configured to be positioned at a location capable of acquiring an enlarged image of an observation target in an observation target region including the cantilever and the sample;
a first drive source configured to operate to move the observation target;
a second drive source configured to operate to move the optical microscope; and
a control device configured to control the first drive source and the second drive source.

The control device is configured to perform control to
move the optical microscope from an initial position to a position at which the optical microscope is focused on the observation target while confirming the focus,
store information capable of identifying a relative position between the optical microscope and the observation target in a focused state,
move the optical microscope to the relative position based on information capable of identifying the stored relative position when newly focusing the optical microscope on the observation target, and then
move the optical microscope to a position at which the optical microscope is focused on the observation target while confirming the focus.

A scanning probe microscope according to another aspect of the present invention includes:
a cantilever equipped with a probe to be positioned to face a sample;
an optical microscope configured to be positioned at a location capable of acquiring an enlarged image of the cantilever;
a first pulse motor configured to operate for moving the cantilever;
a second pulse motor configured to operate for moving the optical microscope; and a control device configured to control the first pulse motor and the second pulse motor,

The control device is configured to
be capable of performing control to move the cantilever from a first initial position by a movement distance corresponding to a count of the first pulse supplied to the first pulse motor,
be capable of performing control to move the optical microscope from a second initial position by a movement distance corresponding to a count of the second pulse supplied to the second pulse motor,
move the optical microscope from the second initial position to a position at which the optical microscope is focused on the cantilever while confirming the focus,
store a supply count of the first pulse and a supply count of the second pulse, which are capable of identifying a relative position between the optical microscope and the cantilever in a focused state, and
perform control to move the optical microscope to the relative position based on the stored supply count of the first pulse and the stored supply count of the second pulse when newly focusing the optical microscope on the cantilever, and then move the optical microscope to a position at which the optical microscope is focused on the cantilever while confirming the focus.

The time required to focus an optical microscope can be shortened.

### BRIEF DESCRIPTION OF THE DRAWINGS

FIG. 1 is a side view schematically showing the configuration of the main structure of a scanning probe microscope 1 of an embodiment.

FIG. 2 is a block diagram schematically showing the configuration of the main structure of the scanning probe microscope 1 according to an embodiment and the configuration of a control circuit.

FIG. 3 is a flowchart of focus adjustment processing.

### EMBODIMENTS FOR CARRYING OUT THE INVENTION

Hereinafter, some embodiments of the present invention will be described in detail with reference to the drawings. Note that, hereinafter, the same or equivalent part in the figures is assigned by the same reference symbol, and the description thereof will not be repeated.

### Configuration of Main Structure and Control Circuit of Scanning Probe Microscope 1

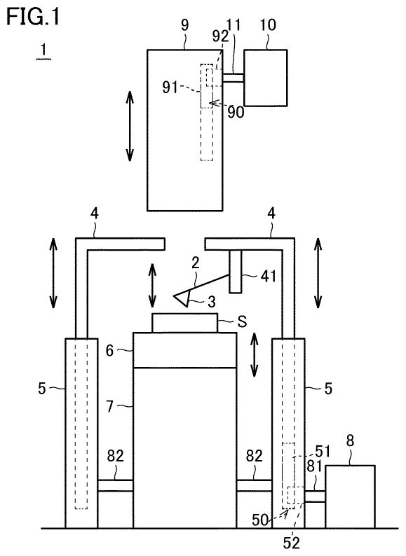

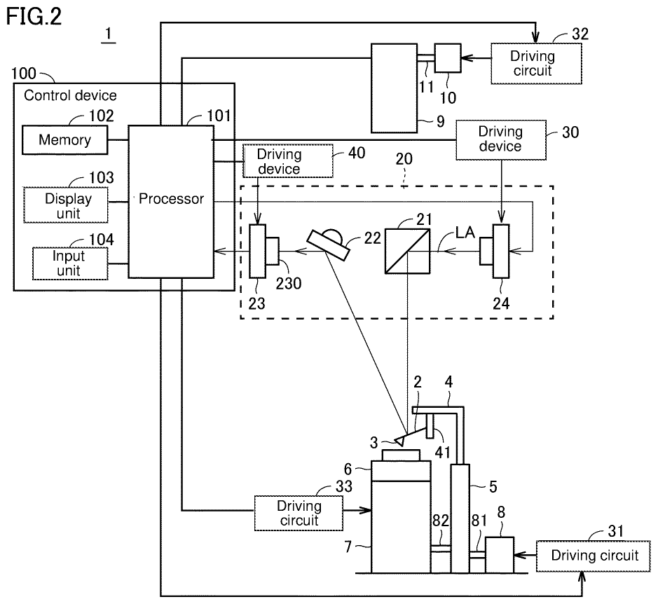

FIG. 1 is a side view schematically showing the configuration of the main structure of the scanning probe microscope 1 of an embodiment. FIG. 2 is a block diagram schematically showing the configuration of the main structure of the scanning probe microscope 1 according to the embodiment and the configuration of a control circuit. In the following description, the ground plane of the scanning probe microscope 1 is referred to as the XY plane, and the axis perpendicular to the XY plane is referred to as the Z-axis.

Referring to FIG. 1 and FIG. 2, the scanning probe microscope 1 is equipped with, as its principal constituent elements, a cantilever 2, a holder 41, a head 4, a case 5, an optical system 20, driving devices 30, 40, a scanner 7, a sample holder 6, an optical microscope 9, driving circuits 31, 32, 33, a first pulse motor 8, a second pulse motor 10, motor shafts 81, 11, a connection mechanism 82, and a control device 100. In FIG. 2, a diagram in which a part of the head 4 is omitted is shown to clarify the configuration of the control system.

The cantilever 2 is provided so as to be positioned above the sample S placed on the sample holder 6 during the measurement of the sample S. The cantilever 2 is supported by the holder 41 in such a manner that the rear end, which is one end, is movable in the vertical direction, and has a probe 3 at the tip, which is the other end.

The holder 41 is attached to one of the arm members of the head 4, which are composed of a plurality of arm members interlockingly connected by the connection mechanism 82. The holder 41 moves vertically in the Z-axis direction in accordance with the vertical movements of the head 4 movable in the Z-axis direction. The head 4 is driven vertically in the Z-axis direction by the drive mechanism 50, which is composed of a motion direction conversion mechanism. This mechanism is configured such that a threaded portion 51, which is formed at the portion covered by the cylindrical case 5 in which a part of the Z-direction member is housed, is engaged with a gear 52 coaxially mounted on the motor shaft 81 of the first pulse motor 8. In the drive mechanism 50, the rotational movement of the motor shaft 81 is converted into the movement of the head 4 in the Z-axis direction. The head 4 can be moved in the XY direction as well by a drive mechanism other than the drive mechanism 50.

The driving circuit 31 drives the first pulse motor 8 by supplying pulses to the first pulse motor 8 as the drive source. The driving circuit 32 drives the second pulse motor 10 by supplying pulses to the second pulse motor 10 as the drive source. The first pulse motor 8 rotates by the first rotation amount each time one pulse is supplied. The second pulse motor 10 rotates by the first rotation amount each time one pulse is supplied.

The optical system 20 irradiates the laser light LA onto the back surface of the cantilever 2 (the surface opposite to the surface facing the sample S) during the measurement, and detects the laser light LA reflected from the back surface of the cantilever 2. The control device 100 calculates the deflection of the cantilever 2 based on the laser light LA detected by the optical system 20. The optical system 20 is equipped with a laser light source 24, a beam splitter 21, a reflective mirror 22, and a detector 23.

The laser light source 24 is composed of a laser oscillator or the like that emits laser light LA. The laser light LA emitted from the laser light source 24 is reflected by the beam splitter 21 and irradiates the cantilever 2. The laser light LA irradiated onto the cantilever 2 is reflected by the back surface of the cantilever 2 and further reflected by the reflective mirror 22 to enter the detector 23. The detector 23 has a light-receiving surface 230 for receiving the laser light LA reflected from the back surface of the cantilever 2. The detector 23 detects the laser light LA received by the light-receiving surface 230 and outputs the obtained detection result to the control device 100.

The driving device 30 includes a drive source composed of a motor and a drive mechanism for moving the laser light source 24 by the driving force of the drive source. The driving device 30 moves the laser light source 24 along a plane (in the example shown in FIG. 1, the YZ plane) orthogonal to the optical axis of the laser light LA emitted by the laser light source 24. The driving device 30 moves the laser light source 24 by driving the motor in accordance with the control signal from the control device 100 to adjust the optical axis of the laser light LA so that the laser light LA is reflected by the cantilever 2.

The driving device 40 includes a drive source composed of a motor and a drive mechanism for moving the detector 23 by the driving force of the drive source. The driving device 40 moves the detector 23 along a plane (in the example shown in FIG. 1, the YZ plane) orthogonal to the optical axis of the laser light LA reflected by the reflective mirror 22 and enters the light-receiving surface 230. The driving device 40, for example, moves the detector 23 by driving the motor in accordance with the control signal from the control device 100 to adjust the position of the photodetector 23 ensuring that the laser light LA reflected by the cantilever 2 is incident on the center of the light-receiving surface 230.

The scanner 7 is cylindrical in shape. The sample S is held on the sample holder 6 placed on the scanner 7. The scanner 7 has an XY scanner that scans the sample S in the two mutually orthogonal X and Y axis directions, and a Z scanner that moves the sample S slightly in a Z axis direction orthogonal to the X-axis and the Y-axis. The XY scanner and the Z scanner each have a piezoelectric element as its drive source, which is deformed by the voltage applied from the driving circuit 33. The scanner 7 is driven in the three-dimensional directions by the XY scanner and the Z scanner.

The driving circuit 33 drives the scanner 7 in three-dimensional directions (the X-axis direction, the Y-axis direction, and the Z-axis direction) by applying a voltage to the piezoelectric elements in the scanner 7. This allows the driving circuit 33 to change the relative position between the sample S placed on the sample holder 6 on the scanner 7 and the probe 3.

The optical microscope 9 is positioned above the probe 3 and can acquire the enlarged image of the observation target by imaging the observation target region, including the cantilever 2 and the sample S, with an image sensor or the like. The optical microscope 9 acquires observation image data by imaging the observation target present in the imaging field of view. The optical microscope 9 outputs the acquired image data to the control device 100. The image data acquired by the optical microscope 9 is used, for example, to adjust the optical axis of the laser light LA and to focus the optical microscope 9 on the observation target.

The optical microscope 9 is driven vertically in the Z-axis direction by a drive mechanism 90 composed of an operation direction conversion mechanism. The mechanism is configured by a threaded portion 91 formed on a member provided in the Z-direction inside the case of the optical microscope 9 and a gear 92 coaxially mounted on the motor shaft 11 of the second pulse motor 10, which engages with the threaded portion 91. In the drive mechanism 90, the rotational movement of the motor shaft 11 is converted into the movement of the optical microscope 9 in the Z-axis direction.

The control device 100 controls the operation of each part of the scanning probe microscope 1. The control device 100 is configured, for example, according to a general-purpose computer architecture. Note that the control device 100 can be implemented in the scanning probe microscope 1 using dedicated hardware. The control device 100 is equipped with a processor 101, a memory 102, a display unit 103, and an input unit 104. Further, the control device 100 is equipped with a processor 101 and a memory 102 and may be configured such that the display unit 103 and the input unit 104 are connected to the control device 100 as a display unit and an input unit that are not part of the control device 100.

The processor 101 is an arithmetic processing unit, typically a CPU (Central Processing Unit) and an MPU (Multi Processing Unit). The processor 101 reads and executes the programs stored in the memory 102 to realize each of the processing of the control device 100 described below. Although the example shown in FIG. 2 shows a configuration with a single processor, the control device 100 may have a plurality of processors.

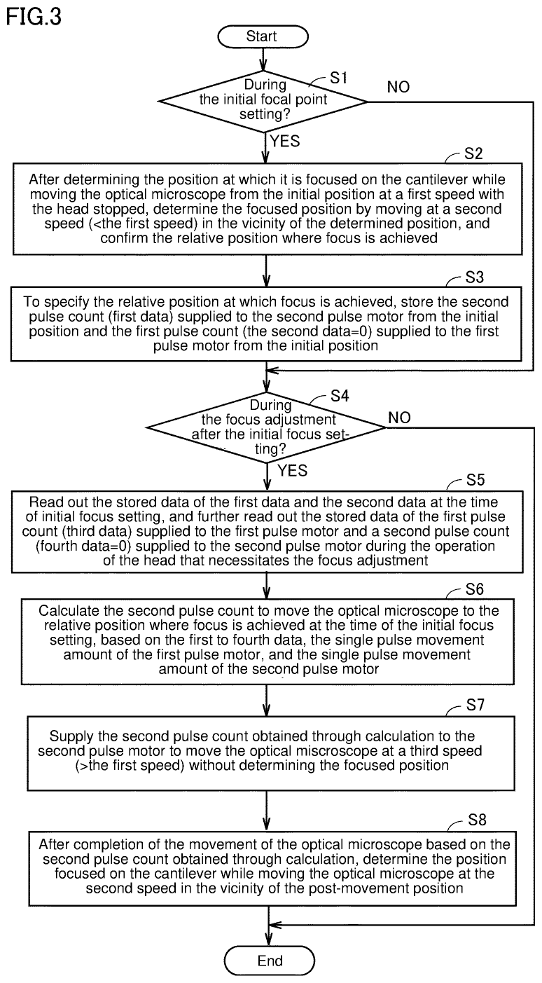

The memory 102 is realized by a RAM (Random Access Memory), a ROM (Read Only Memory), or a non-volatile memory, such as a flash memory. The memory 102 stores programs to be executed by the processor 101, and data to be used by the processor 101. For example, the memory 102 stores various programs, such as programs for executing the processing shown in FIG. 3.

Note that the memory 102 may be a CD-ROM (Compact Disc-Read Only Memory), a DVD-ROM (Digital Versatile Disk-Read Only Memory), a USB (Universal Serial Bus) memory, a memory card, an FD (Flexible Disk), a hard disk, an SSD (Solid State Drive), a magnetic tape, a cassette tape, an MO (Magnetic Optical Disc), an MD (Mini Disc), an IC (Integrated Circuit) card (excluding memory cards), an optical card, a mask ROM, or an EPROM, as long as the memory can non-temporarily record programs in a format readable by the control device 100 as one type of a computer.

The display unit 103 is composed of a liquid crystal display panel or the like. The display unit 103 displays, for example, the measurement result obtained by the scanning probe microscope 1 or various setting screens for conducting measurements with the scanning probe microscope 1.

The input unit 104 is composed of devices such as a mouse and a keyboard. The input unit 104 is an input interface that accepts information input via the input unit 104. Note that the control device 100 may be equipped with a touch panel that integrates the display unit 103 and the input unit 104.

The control device 100 sends a control signal to the driving circuit 31, which in turn supplies pulses to the first pulse motor 8 in response to the control signal to drive the first pulse motor 8. The control device 100 sends a control signal to the driving circuit 32, which in turn supplies pulses to the second pulse motor 10 in response to the control signal to drive the second pulse motor 10. The control device 100 sends a control signal to the driving circuit 33, and the driving circuit 33 applies a voltage to the scanner 7 corresponding to the control signal to drive the scanner 7.

The control device 100 sends a control signal to the driving device 30, which in turn drives a motor in response to the control signal to thereby move the laser light source 24 by the driving device 30. The control device 100 sends a control signal to the driving device 40, which in turn drives a motor in response to the control signal to thereby move the detector 23 by the driving device 40.

### Focus Adjustment Processing of Optical Microscope 9

Referring to FIG. 3, the focus adjustment processing will be described. The focus adjustment processing is processing to perform a focus adjustment to focus the optical microscope 9 on an observation target, such as the cantilever 2.

FIG. 3 is a flowchart of the focus adjustment processing. The program for executing the focus adjustment processing is stored in the memory 102 of the control device 100 and is executed by the processor 101. In the following description, in order to make it easier to distinguish the names of the pulses, the pulse supplied to the first pulse motor 8 may be referred to as the first pulse, and the pulse supplied to the second pulse motor 10 may be referred to as the second pulse.

The processor 101 performs the following processing in the focus adjustment processing. The processor 101 determines, in Step S1, whether the current moment is the time for the initial focus setting for focusing the optical microscope 9.

When it is determined in Step S1 that it is not the time for the initial focus setting, the processor 101 proceeds to Step S4 described below. On the other hand, when it is determined in Step S1 that it is the time for the initial focus setting, the processor 101 executes the following processing in Step S2.

In Step S2, with the head 4 stopped, the processor 101 determines the position where it is focused on the cantilever 2 based on the images obtained by the optical microscope 9 while moving the optical microscope 9 from its initial position at a first speed, which is comparatively slow. After determining the position, the processor 101 establishes the relative position where it is focused based on the images obtained by the optical microscope 9 while slowly moving the optical microscope 9 at a second speed, which is slower than the first speed, near the determined position.

The “initial position” in Step S2 is, for example, the position at which the optical microscope 9 is the farthest from the cantilever 2. The “position at which it is focused on the cantilever 2 in Step S2 is the position where the focus value, such as the contrast ratio, becomes the largest when comparing a pixel of the cantilever 2 with its adjacent pixels in the surrounding images of the cantilever 2 obtained by the optical microscope 9. In other words, when the difference in the data values identifying the adjacent pixels becomes the largest, it is determined that the focus of the optical microscope 9 is achieved based on the surrounding image of the cantilever 2 obtained by the optical microscope 9.

The “relative position” in Step S2 is the relative position between the position of the optical microscope 9 and the position of the cantilever 2.

Next, in Step S3, in order to identify the relative position between the focused optical microscope 9 and the cantilever 2, the processor 101 stores in the memory 102 the first data as the pulse count of the first pulse supplied to the second pulse motor 10 to move the optical microscope 9 from its initial position at the time of initial focus setting and the second data as the pulse count of the first pulse supplied to the first pulse motor 8 to move the cantilever 2 from its initial position at the time of initial focus setting. At the time of the initial focus setting in this case, the optical microscope 9 was moved with the head 4 stopped, so the second data is “0” because the first pulse count of the first pulse supplied to the first pulse motor 8 was 0 pulses. At the time of the initial focus setting, for example, when the supply count of the second pulse supplied to the second pulse motor 10 from the initial position is 10 pulses, the data of 10 pulses is stored as the first data, and the data of 0 pulses is stored as the second data.

Next, in Step S4, the processor 101 determines whether it is the time for the focus adjustment, which may be performed after completion of the initial focus setting as described above. The focus adjustment performed after completion of the initial focus setting means, for example, when the cantilever 2 is moved vertically by moving the head 4 vertically with the optical microscope 9 in a fixed position in order to replace the cantilever 2 or to measure a sample S, etc., and the optical microscope 9 become unfocused on the cantilever 2, and a focus adjustment operation is performed.

The processor 101 terminates the processing when it is determined in Step S4 that it is not during the time for focus adjustment. On the other hand, when it is determined in Step S4 that it is the time of focus adjustment, the processor 101 reads from the memory 102 in Step S5 the stored data of the first data and the second data at the time of initial focus setting. Further, the processor 101 reads from the memory 102 the stored data of the third pulse count as the pulse count supplied to the first pulse motor 8 and the fourth data as the pulse count of second count supplied to the second pulse motor 10 at the time of the operation of the head 4 that requires the focus adjustment, such as when the head 4 is moved vertically with the optical microscope 9 in a fixed position to replace the cantilever 2 and to measure the sample S, for example. With this, the pulse count supplied to the first pulse motor 8 and the second pulse motor 10 during the operation of the head 4, which requires focus adjustment, is obtained.

When the head 4 is driven in such an operation mode that focus adjustment is required, for example, to replace the cantilever 2 and when the head 4 is moved vertically with the optical microscope 9 in a fixed position to measure the sample S, the processor 101 stores the third data as the pulse count of the first pulse supplied to the first pulse motor 8 and the fourth data as the pulse count of the second pulse supplied to the second pulse motor 10 in the memory 102 by a program other than the program shown in FIG. 3. The data stored in the memory 102 when the head 4 is driven in such a manner that focus adjustment is required is read out in Step S5.

In this case, the third data is “0” because the pulse count of the second pulse supplied to the second pulse motor 10 was 0 pulses since the head 4 was moved with the optical microscope 9 stopped. For example, when the pulse count of the first pulse supplied to operate the head 4 is 20 pulses when the head 4 is driven in an operating mode that requires focus adjustment, the data of 20 pulses is stored as the third data, and the data of 0 pulses is stored as the fourth data.

As described above, in Step S5, the first data and the second data stored in the memory 102 in S3 at the time of initial focus setting are read out. Further, the data (third data) of the pulse count of the first pulse supplied to the first pulse motor 8 during the operation of the head 4 and the data (fourth data) of the pulse number of the second pulse supplied to the second pulse motor 10 during the operation of the head 4 during the operation of head 4, which were stored in the memory 102 at the time of the operation of the head 4 when focus adjustment is required, are read out.

In Step S6, based on the first data to the fourth data read in S5, the single pulse movement amount of the first pulse motor 8, and the single pulse movement amount of the second pulse motor 10, the processor 101 calculates the second pulse count supplied to the second pulse motor 10 to move the optical microscope 9 until it reaches the relative position between the cantilever 2 and the optical microscope 9 where it was focused at the initial focus setting, in order to focus the optical microscope 9 on the cantilever 2.

The “single pulse movement amount of the first pulse motor 8” in Step S6 refers to the operation amount of the head 4 which is operated when a single pulse is supplied to the first pulse motor 8, i.e., the movement amount of the cantilever 2. The “single pulse movement amount of the second pulse motor 10” in Step S6 refers to the movement amount of the optical microscope 9 that is operated when a single pulse is supplied to the second pulse motor 10.

In Step S6, after the initial focus setting, in order to again focus the optical microscope 9 on the cantilever 2 when the head 4 is driven in an operation manner that requires the focus adjustment, the pulse count supplied to the second pulse motor 10 is calculated to move the optical microscope 9 at a higher speed than at the initial focus setting until it reaches the relative position between the cantilever 2 and the optical microscope 9 where it was focused at the time of the initial focus setting.

In Step S6, the pulse count supplied to the second pulse motor 10 is calculated as follows. In the first and second data read out in S5, the first data indicates the pulse count of the first pulse supplied to the first pulse motor 8 for moving the cantilever 2 from its initial position at the initial focus setting. The second data indicates the pulse count of the second pulse supplied to the second pulse motor 10 for moving the optical microscope 9 from its initial position at the time of the initial focus setting.

By multiplying the pulse count of the first data by the single pulse movement amount of the second pulse motor 10, the distance that the optical microscope 9 has moved from its initial position at the time of initial focus setting is calculated. As an example, as mentioned above, when the first data is “10 pulses”, the second data is “0 pulses”, the single pulse movement amount of the first pulse motor 8 is “0.2 (mm/pulse)”, and the single pulse movement amount of the second pulse motor 10 is “0.1 (mm/pulse)”, the distance that the cantilever 2 has moved from its initial position is calculated to be 0 mm, and the distance that the optical microscope 9 has moved from its initial position is calculated to be 2.0 mm. Note that more specifically, in order to improve the measurement accuracy of the sample S, the first pulse motor 8 is required to bring the sample S and the cantilever 2 closer together in nm units. Therefore, to enable precise motion control, the single pulse movement amount of the first pulse motor 8 is set to a value on the order of nm, for example. On the other hand, the single pulse movement amount of the second pulse motor 10 is set to a value on the order of μm, which is larger than that of the first pulse motor 8. Further, the general travel distance for the focus adjustment of the optical microscope 9 is, for example, a value in the range of 0.5 mm to 2.0 mm.

The relative position between the initial position of the cantilever 2 and the initial position of the optical microscope 9 has been stored in the memory 102 in advance. Therefore, in Step S6, based on the pulse count of the first data, the single pulse movement amount of the first pulse motor 8, the pulse count of the second data, and the single pulse movement amount of the second pulse motor 10, it is possible to determine the relative position (distance) between the optical microscope 9 and the cantilever 2 in the focused state at the time of the initial focus setting.

By multiplying the pulse count of the fourth data by the single pulse movement amount of the second pulse motor 10, the distance that the optical microscope 9 has moved from its position at the initial focus setting can be calculated when the head 4 is driven in an operation manner requiring focus adjustment after the initial focus setting. As an example, as mentioned above, when the third data is “20 pulses,” the fourth data is “0 pulses,” the single pulse movement amount of the first pulse motor 8 is “0.2 (mm/pulse),” and the single pulse movement amount of the second pulse motor 10 is “0.1 (mm/pulse),” the distance that the cantilever 2 has moved from its initial position is calculated to be 4.0 mm, and the distance that the optical microscope 9 has moved from its initial position is calculated to be 0 mm.

As described above, in Step S6, based on the pulse count of the third data, the single pulse movement amount of the first pulse motor 8, the pulse count of the fourth data, and the single pulse movement amount of the second pulse motor 10, it is possible to obtain the relative position (distance) between the optical microscope 9 and the cantilever 2 in a state in which the head 4 is driven in such a manner that focus adjustment is required.

Then, in Step S6, based on the third data pulse count, the single pulse movement amount of the first pulse motor 8, the pulse count of the fourth data, and the single pulse movement amount of the second pulse motor 10, the pulse count of the first data is calculated from the relative position (distance) between the optical microscope 9 and the cantilever 2 in a state in which the head 4 is driven in such a manner that focus adjustment is required. Based on the single pulse movement amount of the first pulse motor 8, the pulse count of the second data, and the single pulse movement amount of the second pulse motor 10, the pulse count of the second pulse of the second pulse motor 10 required to move the optical microscope 9 to the relative position (distance) between the optical microscope 9 and the cantilever 2 in the focused state at the time of initial focus setting is calculated.

In such calculations, for example, the difference between the relative position (distance) in the state in which the head 4 is driven in such an operation manner requiring adjustment and the relative position (distance) at the time of the initial focus setting is calculated, and the pulse count of the second pulse of the second pulse motor 10 required to move the optical microscope 9 until the calculated difference in the relative position (distance) becomes “0” is calculated based on the difference in the relative position (distance) and the single pulse movement amount of the second pulse motor 10.

Next, in Step S7, the processor 101 supplies a second pulse of the pulse count obtained by the calculation in Step S6 to the second pulse motor 10, and performs control to move the optical microscope 9 at a third speed, which is higher than the first speed at the initial focus setting, without determining the position where it is focused based on the images obtained by the optical microscope 9. With this, it is possible to move the optical microscope 9 at a relatively high speed to the position where it is presumed to be focused on the cantilever 2.

Next, in Step S8, after the movement of the optical microscope 9 has been completed in Step S7 based on the pulse count calculated in Step S6, the processor 101 determines the focused position based on the image obtained by the optical microscope 9, while slowly moving the optical microscope 9 at the same speed as the second speed at the time of the initial focus setting in the vicinity after the movement. With this, it is possible to perform the measurement to accurately determine the position at which the optical microscope 9 is focused on the cantilever 2 by image processing. In this manner, in Step S8, it is possible to achieve the focus adjustment after the initial focus setting.

By performing the focus adjustment processing described with reference to FIG. 3, the following effects can be achieved. In the case of storing information, such as data on the supply count of the first pulse count and the supply count of the second pulse count, capable of identifying the relative position between the optical microscope 9 and the observation target, such as the cantilever 2, in the focused state, and focusing the optical microscope 9 on a new observation target, after moving the optical microscope 9 to the relative position in the focused state based on the information capable of identifying the stored relative position, a control is performed to move the optical microscope 9 while confirming the focal point until the optical microscope 9 is focused on the observation target. This eliminates the need to confirm the focus while adjusting the position of the optical microscope 9 until it becomes the relative position between the optical microscope 9 and the observation target in the focused state when focusing the optical microscope 9 on a new observation target. Therefore, it is possible to shorten the time required for focusing the optical microscope 9. In the case of not confirming the focus in the middle of moving the optical microscope 9, it eliminates the need to execute various processing such as image processing to confirm the focus. Therefore, it is possible to move the optical microscope 9 at a higher speed without waiting for the execution of various processes, compared with the case of confirming the focus in the middle of moving the optical microscope 9. Thus, the optical microscope 9 can be moved at a higher speed, such as the third speed, and therefore, it is possible to shorten the time required for focus adjustment of the optical microscope 9.

### Modifications

(1) In the embodiment described above, an example is shown in which the observation target of the optical microscope 9 is the cantilever 2. However, the observation target of the optical microscope 9 is not limited thereto, and may be any observation target other than the cantilever 2, such as a sample S.

(2) In the case where the observation target of the optical microscope 9 is the sample S, the optical microscope 9 is focused on the sample S.

(3) In the case where the observation target of the optical microscope 9 is the sample S, the piezoelectric element of the scanner 7 is the drive source of the observation target.

(4) In the case where the sample S is the observation target, the voltage applied from the driving circuit 33 may be used as information that can identify the relative position between the optical microscope 9 and the sample S.

(5) The drive mechanism 50 and the drive mechanism 90 may use other drive mechanisms, such as rack-and-pinion mechanisms, for at least one of them.

(6) A pulse motor, such as the first pulse motor 8 and the second pulse motor 10, includes any type of motor that is driven by being supplied with pulses, such as stepper motors.

(7) In the focus adjustment processing in FIG. 3, an example is shown in which the optical microscope 9 is moved with respect to the cantilever 2 at the third speed to the relative position that was determined to be focused at the initial focus setting, and then the focus position is determined and fixed in the vicinity of the position after the movement. However, not limited to this, after the optical microscope 9 is moved at the third speed to a position that is a predetermined distance (e.g., several mm) forward or backward from the relative position that was determined to be focused at the initial focus setting, the focused position may be determined and fixed in the vicinity of the position after the movement, including the relative position that was determined to be focused at the time of initial setting.

### Appendix

The scanning probe microscope of the present disclosure (scanning probe microscope 1) has the following features

(1) A scanning probe microscope comprising:
a cantilever (cantilever 2) equipped with a probe (probe 3) to be positioned to face a sample (sample S); and
an optical microscope (optical microscope 9) configured to be positioned at a location capable of acquiring an enlarged image of an observation target (cantilever 2 or sample S) in an observation target region including the cantilever (cantilever 2) and the sample (sample S);
a first drive source (first pulse motor 8) configured to operate to move the observation target (cantilever 2);
a second drive source (second pulse motor 10) configured to operate to move the optical microscope (optical microscope 9); and
a control device (control device 100) configured to control the first drive source (first pulse motor 8) and the second drive source (second pulse motor 10),
wherein the control device (control device 100) is configured to perform control to
move the optical microscope (optical microscope 9) from an initial position to a position at which the optical microscope (optical microscope 9) is focused on the observation target (cantilever 2 or sample S) while confirming the focus (Step S2),
store information (supply count of the first pulse and supply count of the second pulse) capable of identifying a relative position between the optical microscope (optical microscope 9) and the observation target in a focused state (Step S3),
move the optical microscope (optical microscope 9) to the relative position based on information (data of the supply count of the first pulse and the supply count of the second pulse) capable of identifying the stored relative position when newly focusing the optical microscope (optical microscope 9) on the observation target (cantilever 2 or sample S) (Step S7), and then
move the optical microscope (optical microscope 9) to a position at which the optical microscope (optical microscope 9) is focused on the observation target (cantilever 2 or sample S) while confirming the focus (Step S8).

With such a configuration, the control device is configured to perform control to store information (the supply count of the first pulse and the supply count of the second pulse) capable of identifying a relative position between the optical microscope (the optical microscope 9) and the observation target (the cantilever 2 or the sample S) in a focused state, move the optical microscope (the optical microscope 9) to the relative position in the focused state based on information (the data on the supply count of the first pulse and the supply count of the second pulse) capable of identifying the stored relative position when newly focusing the optical microscope (the optical microscope 9) on the observation target (the cantilever 2 or the sample S), and then move the optical microscope (the optical microscope 9) to a position at which the optical microscope (the optical microscope 9) is focused on the observation target (the cantilever 2 or the sample S) while confirming the focus. This eliminates the need to confirm the focus of the optical microscope (optical microscope 9) during the process of moving the optical microscope (the optical microscope 9) to the relative position between the optical microscope (the optical microscope 9) and the observation target (the cantilever 2 or the sample S) in the focused state when newly focusing the optical microscope (optical microscope 9) on an observation target (the cantilever 2 or the sample S), thereby reducing the time required for focusing the optical microscope (optical microscope 9).

(2) A scanning probe microscope comprising:
a cantilever (the cantilever 2) equipped with a probe (the probe 3) to be positioned to face a sample (the sample S);
an optical microscope (the optical microscope 9) configured to be positioned at a location capable of acquiring an enlarged image of the cantilever (the cantilever 2);

a first pulse motor (the first pulse motor 8) configured to operate for moving the cantilever (the cantilevers 2);
a second pulse motor (the second pulse motor 10) configured to operate for moving the optical microscope (the optical microscope 9); and
a control device (the control device 100) configured to control the first pulse motor (the first pulse motor 8) and the second pulse motor (the second pulse motor 10),
wherein the control device (the control device 100) is configured to
be capable of performing control to move the cantilever (the cantilever 2) from a first initial position by a movement distance corresponding to a count of the first pulse supplied to the first pulse motor (the first pulse motor 8),
be capable of performing control to move the optical microscope (the optical microscope 9) from a second initial position by a movement distance corresponding to a count of the second pulse supplied to the second pulse motor (the second pulse motor 10),
move the optical microscope (the optical microscope 9) from the second initial position to a position at which the optical microscope (the optical microscope 9) is focused on the cantilever (the cantilever 2) while confirming the focus (Step S2),
store a supply count of the first pulse and a supply count of the second pulse, which are capable of identifying a relative position between the optical microscope (the optical microscope 9) and the cantilever (the cantilever 2) in a focused state (Step S3), and
perform control to move the optical microscope (the optical microscope 9) to the relative position based on the stored supply count of the first pulse and the stored supply count of the second pulse when newly focusing the optical microscope (the optical microscope 9) on the cantilever (the cantilever 2) (Step S7), and then
move the optical microscope (the optical microscope 9) to a position at which the optical microscope (the optical microscope 9) is focused on the cantilever (the cantilever 2) while confirming the focus.

According to such a configuration, it is configured to store a supply count of the first pulse and a supply count of the second pulse, which are capable of identifying a relative position between the optical microscope (the optical microscope 9) and the cantilever (the cantilever 2) in a focused state, and perform control to move the optical microscope (the optical microscope 9) to the relative position based on the stored supply count of the first pulse and the stored supply count of the second pulse when newly focusing the optical microscope (the optical microscope 9) on the cantilever (the cantilever 2), and then move the optical microscope (the optical microscope 9) to a position at which the optical microscope (the optical microscope 9) is focused on the cantilever (the cantilever 2) while confirming the focus. Therefore, in the case of newly focusing the optical microscope (the optical microscope 9) on a cantilever (the cantilever 2), it becomes unnecessary to confirm the focus during the movement of the optical microscope (the optical microscope 9) to the relative position between the optical microscope (the optical microscope 9) and the cantilever (the cantilever 2) in a focused state. Therefore, it is possible to shorten the time required for the focusing of the optical microscope (the optical microscope 9).

(3) The first pulse motor (the first pulse motor 8) moves the cantilever (the cantilever 2) by a first distance each time the first pulse is supplied, and the second pulse motor (the second pulse motor 10) moves the optical microscope (the optical microscope 9) by a second distance each time the second pulse is supplied.

According to this configuration, the first pulse motor (the first pulse motor 8) moves the cantilever (the cantilever 2) by a first distance with each supply of the first pulse, and the second pulse motor (the second pulse motor 10) moves the optical microscope (optical microscope 9) by a second distance with each supply of the second pulse. Therefore, by the relation between the supply count of the first pulse and the supply count of the second pulse, the relative position between the optical microscope (the optical microscope 9) and the cantilever (the cantilever 2) in a focused state can be specified.

(4) When moving the optical microscope (the optical microscope 9) to the relative position based on the stored supply count of the first pulse and the stored supply count of the second pulse, the control device (the control device 100) sets a count of the second pulse supplied to the second pulse motor (the second pulse motor 10) based on the stored supply count of the first pulse and the stored supply count of the second pulse, a first distance that the cantilever (the cantilever 2) moves each time the first pulse is supplied, and a second distance that the optical microscope (the optical microscope 9) moves each time the second pulse is supplied (Step S6).

According to this configuration, when moving the optical microscope (the optical microscope 9) to the relative position between the optical microscope (the optical microscope 9) and the cantilever (the cantilever 2) in the focused state, based on the stored supply count of the first pulse and the stored supply count of the second pulse, the first distance that the cantilever (the cantilever 2) moves with each supply of the first pulse, and the second distance that the optical microscope (the optical microscope 9) moves with each supply of the second pulse, the count of the second pulse supplied to the second pulse motor (the second pulse motor 10) is set. Therefore, the movement amount of the optical microscope (the optical microscope 9) to the relative position between the optical microscope (the optical microscope 9) and the cantilever (the cantilever 2) in the focused state can be determined by the count of the second pulse supplied to the second pulse motor (the second pulse motor 10).

(5) It further comprises:
a first drive mechanism (the drive mechanism 50) configured to move the cantilever (the cantilever 2); and
a second drive mechanism (the drive mechanism 9) configured to move the optical microscope (the optical microscope 9),
wherein the first pulse motor (the first pulse motor 8) moves the cantilever (the cantilever 2) by the first drive mechanism (the drive mechanism 50) each time the first pulse is supplied, and
wherein the second pulse motor (the second pulse motor 10) moves the optical microscope (the optical microscope 9) by the second drive mechanism (the drive mechanism 90) each time the second pulse is supplied.

According to this configuration, the first pulse motor (the first pulse motor 8) moves the cantilever (the cantilever 2) by a first distance with each supply of the first pulse, and the second pulse motor (the second pulse motor 10) moves the optical microscope (the optical microscope 9) by a second distance with each supply of the second pulse. By the pulse count supplied to a pulse motor, such as the first pulse motor (the first pulse motor 8) and the second pulse motor (the second pulse motor 10), the movement amount of the drive target, such as a cantilever (the cantilever 2) and the optical microscope (the optical microscope 9) can be easily set.

Note that the embodiments disclosed here should be considered illustrative and not restrictive in all respects. It should be noted that the scope of the invention is indicated by claims and is intended to include all modifications in the meaning and scope of the claims and equivalents.

### DESCRIPTION OF REFERENCE SYMBOLS

S: Sample
3: Probe
2: Cantilever
9: Optical microscope
8: First pulse motor
10: Second pulse motor
50, 90: Drive mechanism
1: Scanning probe microscope

1. A scanning probe microscope comprising:
a cantilever equipped with a probe to be positioned to face a sample; and
an optical microscope configured to be positioned at a location capable of acquiring an enlarged image of an observation target in an observation target region including the cantilever and the sample;
a first drive source configured to operate to move the observation target;
a second drive source configured to operate to move the optical microscope; and
a control device configured to control the first drive source and the second drive source,
wherein the control device is configured to perform control to
move the optical microscope at a first rate from an initial position to a position at which the optical microscope is focused on the observation target while confirming the focus,
store information capable of identifying a relative position between the optical microscope and the observation target in a focused state,
move the optical microscope at a third rate faster than the first rate to the relative position based on information capable of identifying the stored relative position when newly focusing the optical microscope on the observation target, and then
move the optical microscope at a second rate slower than the first rate to a position at which the optical microscope is focused on the observation target while confirming the focus.

2. A scanning probe microscope comprising:
a cantilever equipped with a probe to be positioned to face a sample;
an optical microscope configured to be positioned at a location capable of acquiring an enlarged image of the cantilever;
a first pulse motor configured to operate for moving the cantilever;
a second pulse motor configured to operate for moving the optical microscope; and
a control device configured to control the first pulse motor and the second pulse motor,
wherein the control device is configured to
be capable of performing control to move the cantilever from a first initial position by a movement distance corresponding to a count of the first pulse supplied to the first pulse motor,
be capable of performing control to move the optical microscope from a second initial position by a movement distance corresponding to a count of the second pulse supplied to the second pulse motor,
move the optical microscope at a first rate from the second initial position to a position at which the optical microscope is focused on the cantilever while confirming the focus,
store a supply count of the first pulse and a supply count of the second pulse, which are capable of identifying a relative position between the optical microscope and the cantilever in a focused state, and
perform control to move the optical microscope at a third rate faster than the first rate to the relative position based on the stored supply count of the first pulse and the stored supply count of the second pulse when newly focusing the optical microscope on the cantilever, and then
move the optical microscope at a second rate slower than the first rate to a position at which the optical microscope is focused on the cantilever while confirming the focus.

3. The scanning probe microscope as recited in claim 2,
wherein the first pulse motor moves the cantilever by a first distance each time the first pulse is supplied, and
wherein the second pulse motor moves the optical microscope by a second distance each time the second pulse is supplied.

4. The scanning probe microscope as recited in claim 2,
wherein when moving the optical microscope to the relative position based on the stored supply count of the first pulse and the stored supply count of the second pulse, the control device sets a count of the second pulse supplied to the second pulse motor based on the stored supply count of the first pulse and the stored supply count of the second pulse, a first distance that the cantilever moves each time the first pulse is supplied, and a second distance that the optical microscope moves each time the second pulse is supplied.

5. The scanning probe microscope as recited in claim 2, further comprising:
a first drive mechanism configured to move the cantilever; and
a second drive mechanism configured to move the optical microscope,
wherein the first pulse motor moves the cantilever by the first drive mechanism each time the first pulse is supplied, and
wherein the second pulse motor moves the optical microscope by the second drive mechanism each time the second pulse is supplied.
